(19) United States
(12) Patent Application Publication
(10) Pub. No.: US 2024/0179608 A1
(43) Pub. Date: May 30, 2024

(54) IMPROVEMENTS IN AND RELATING TO DATA LOSS DUE TO DONOR CHANGE IN A MULTI-HOP NETWORK

(71) Applicant: Samsung Electronics Co., Ltd., Suwon-si, Gyeonggi-do (KR)

(72) Inventors: Milos TESANOVIC, Staines (GB); June HWANG, Suwon-si (KR); Weiwei WANG, Beijing (CN)

(21) Appl. No.: 18/284,693

(22) PCT Filed: Mar. 29, 2022
(86) PCT No.: PCT/KR2022/004453

§ 371 Date: Sep. 28, 2023

(30) Foreign Application Priority Data
Mar. 30, 2021 (WO) PCT/CN2021/083963
Jan. 21, 2022 (GB) 2200763.7

(51) Int. Cl. H04W 40/22; H04W 40/36

(52) U.S. Cl. CPC H04W 40/22; H04W 40/36

(57) ABSTRACT

The disclosure relates to a 5G or 6G communication system for supporting a higher data transmission rate. Disclosed is a method of routing data in a network, wherein a data transfer path is migrated from terminating at a first donor Distributed Unit, DU, to terminating at a second donor DU, comprising the step of either: a) configuring at least one node impacted by the migration and then using a default configuration, comprising a default identifier and/or transport channel, to re-route a packet impacted by the migration; or b) changing a part of a packet affected by the migration.

### TECHNICAL FIELD

The present invention relates particularly to the issue of possible data loss in an Integrated Access and Backhaul (IAB) network in the event of a change of donor.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present invention relates particularly to the issue of possible data loss in an Integrated Access and Backhaul (IAB) network in the event of a change of donor. The change of donor can occur for a number of reasons and the result can be loss of data. The problem mostly occurs in the uplink direction. However, embodiments of the invention may find utility in other forms of relay, device to device (D2D) or multi-hop networks, with IAB being only one form of such a network. Embodiments may further find utility in the downlink data transfer direction in such a network.

Any potential data loss is clearly undesirable, and it is an aim of embodiments of the present invention to address this problem.

The technical subjects pursued in the disclosure may not be limited to the above-mentioned technical subjects, and other technical subjects which are not mentioned may be clearly understood, through the following descriptions, by those skilled in the art to which the disclosure pertains.

### Solution to Problem

According to a first aspect of the present invention, there is provided a method of routing data in a network, wherein a data transfer path is migrated from terminating at a first donor Distributed Unit, DU, to terminating at a second donor DU, comprising the step of either: a) configuring at least one node impacted by the migration and then using a default configuration, comprising a default identifier and/or transport channel, to re-route a packet impacted by the migration; or b) changing a part of a packet affected by the migration.

In an embodiment, the network is an Integrated Access and Backhaul, IAB, network.

In an embodiment, the data transfer path is an uplink path and the default configuration is an Uplink, UL, F1-U configuration.

In an embodiment, the default identifier is a Backhaul Adaptation, BAP, routing ID and the transport channel is a Backhaul Radio Link Control Channel, BH RLC CH.

In an embodiment, in case of a), the configuration is achieved by means of an RRCReconfiguration message or by the use of an additional RRCReconfig message after RRCReconfigurationComplete message.

In an embodiment, if there is at least one further descendant node, an RRCReconfiguration message is used to configure a default UL F1-U configuration for the at least one further descendant node.

In an embodiment, the default identifier and transport channel are configured to the at least one descendant node before a parent or migrating node completes a handover procedure.

In an embodiment, in case of b) there further comprises the step of changing a routing configuration.

In an embodiment, the routing configuration is changed simultaneously with the part of the packet or at a later time.

In an embodiment, if the routing configuration is changed simultaneously with the part of the packet, at least one impacted packet is buffered until handover is complete.

In an embodiment, if the routing configuration is changed at a later time, and it is determined that at least one packet is not routable, then the at least one non-routable packet is buffered until the routing configuration is received.

In an embodiment, if the migration involves a change in Control Unit, CU, then the identifier notification is signalled also over Xn.

In an embodiment, the selection of a) or b) is determined on the basis of changes required in network configuration and/or signalling.

In an embodiment, a) is selected if a lack of Quality of Service, QoS, differentiation for buffered packets is acceptable.

In an embodiment, b) is selected if an increase in network signalling is acceptable.

According to a second aspect of the present invention, there is provided a network configured to perform the method of the first aspect.

Embodiments of the present invention provide a means for minimizing data loss in the case of donor-DU migration, which may or may not include a CU change. The applicable scenario is that of node migration, whereby the parent node of a node changes and the donor-DU changes, where the CU may or may not change.

### Advantageous Effects of Invention

The present disclosure provides utility in other forms of relay, device to device (D2D) or multi-hop networks, with IAB being only one form of such a network. The present disclosure provides utility in the downlink data transfer direction in such a network.

Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 shows a prior art configuration illustrating a basic IAB network topology;

FIG. 2 shows a prior art multi-hop IAB network illustrating the re-routing of packets related to an embodiment of the present invention;

FIG. 3 shows a protocol stack associated with IAB networks, known from the prior art;

FIG. 4 shows a data structure for a BAP packet header, known from the prior art;

FIG. 5 shows a message sequence according to a first embodiment of the present invention;

FIG. 6 shows a message sequence according to a second embodiment of the present invention; and

FIG. 7 shows a message sequence according to a third embodiment of the present invention.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

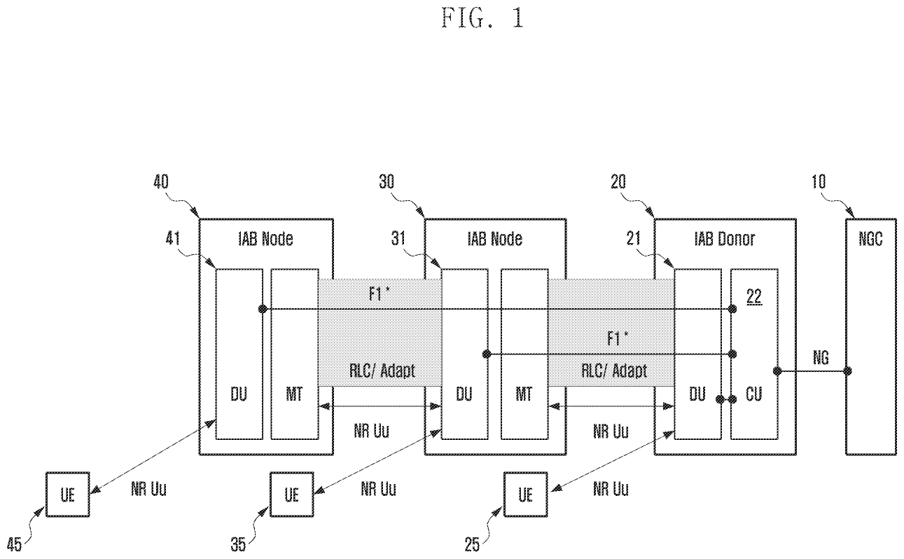

FIG. 1 shows a typical 2-hop IAB (Integrated Access and Backhaul) network, known in the prior art. It shows a Fifth Generation (5G) Core 10, known as a Next Generation Core, NGC. Connected to the core are multiple nodes 20, 30, 40. Under donor node 20, which includes Distributed Unit (DU) 21 and Central Unit (CU) 22, there are two Distributed Units (DU) 31, 41, associated with nodes 30, 40 respectively. UEs 25, 35, 45 are in communication with nodes 20, 30, 40 respectively.

In IAB terminology, an IAB donor 20 terminates the backhaul traffic from distributed IAB nodes 30, 40. Both the IAB donor 20 and nodes 30, 40 serve UEs 25, 35, 45 in the usual way.

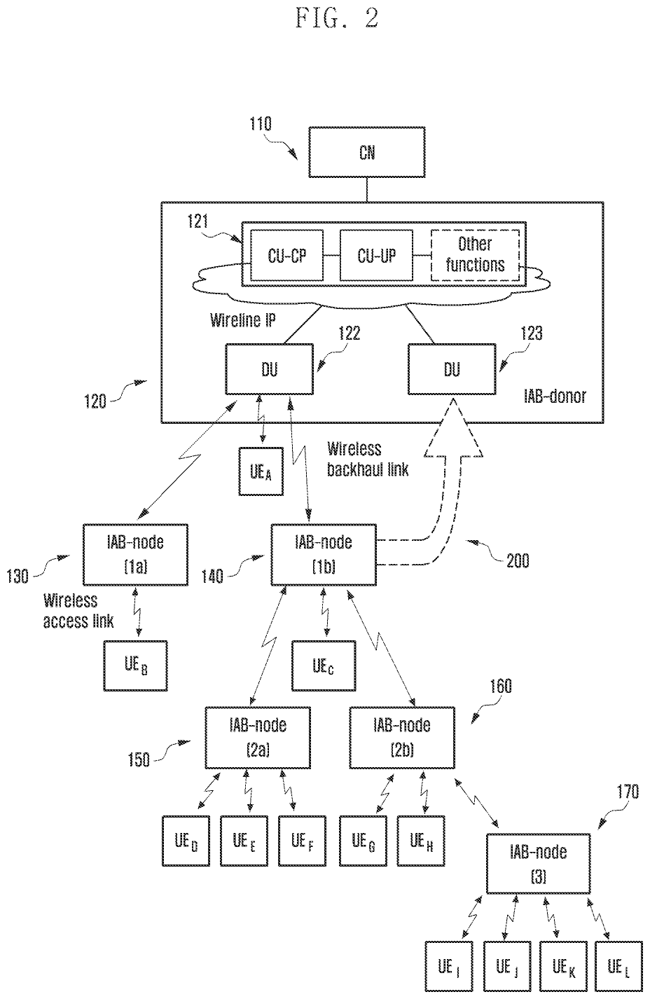

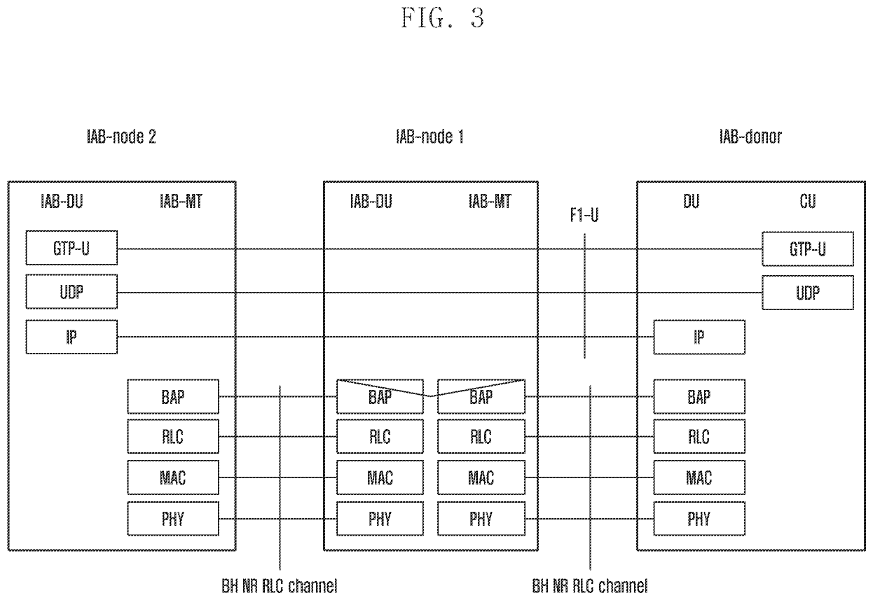

FIG. 1 shows a generalised form of IAB network for context. FIG. 2 shows a configuration which illustrates re-routing from a first DU 122 to a new DU 123, where both DUs 122, 123 are associated with the same CU 121.

In FIG. 2, the jagged arrows connecting IAB nodes are wireless backhaul links and the jagged arrows connecting a UE to a node are wireless access links.

FIG. 2 illustrates the “before” scenario and shows the wireless backhaul links as configured before a rerouting. After the rerouting, the IAB node (1b) 140 is migrated from DU 122 to DU 123. The new wireless backhaul link between IAB node (1b) 140 and DU 123 is represented by arrow 200. All other links between nodes are unchanged.

In other words, IAB node (1b) 140, which has two descendant nodes, IAB node (2a) 150 and IAB node (2b) 160, undergoes inter-DU migration i.e. the backhaul path is terminated at DU 123 instead of DU 122.

Each data packet routed via an IAB network comprises a packet having a Backhaul Adaptation Protocol (BAP) routing ID. In this case, several uplink packets with BAP routing ID towards the old or previous donor DU 122 are buffered at IAB node (1b) 140 and possibly also at a child node e.g. IAB node (2a) 150. Those buffered packets should be routed to the new donor DU 123. However, at the target path, any intermediate node(s) do/does not have routing entry towards the new donor DU 123.

According to the present invention there is provided an apparatus and method as set forth in the appended claims. Other features of the invention will be apparent from the dependent claims, and the description which follows.

According to a first aspect of the present invention, there is provided a method of routing data in a network, wherein a data transfer path is migrated from terminating at a first donor Distributed Unit, DU, to terminating at a second donor DU, comprising the step of either: a) configuring at least one node impacted by the migration and then using a default configuration, comprising a default identifier and/or transport channel, to re-route a packet impacted by the migration; or b) changing a part of a packet affected by the migration.

In an embodiment, the network is an Integrated Access and Backhaul, IAB, network.

In an embodiment, the data transfer path is an uplink path and the default configuration is an Uplink, UL, F1-U configuration.

In an embodiment, the default identifier is a Backhaul Adaptation, BAP, routing ID and the transport channel is a Backhaul Radio Link Control Channel, BH RLC CH.

In the embodiment, in case of a) the configuration is achieved by means of an RRCReconfiguration message or by the use of an additional RRCReconfig message after RRCReconfigurationComplete message.

In an embodiment, if there is at least one further descendant node, an RRCReconfiguration message is used to configure a default UL F1-U configuration for the at least one further descendant node.

In an embodiment, the default identifier and transport channel are configured to the at least one descendant node before a parent or migrating node completes a handover procedure.

In an embodiment, in case of b) there further comprises the step of changing a routing configuration.

In an embodiment, the routing configuration is changed simultaneously with the part of the packet or at a later time.

In an embodiment, if the routing configuration is changed simultaneously with the part of the packet, at least one impacted packet is buffered until handover is complete.

In an embodiment, if the routing configuration is changed at a later time, and it is determined that at least one packet is not routable, then the at least one non-routable packet is buffered until the routing configuration is received.

In an embodiment, if the migration involves a change in Control Unit, CU, then the identifier notification is signalled also over Xn.

In an embodiment, the selection of a) or b) is determined on the basis of changes required in network configuration and/or signalling.

In an embodiment, a) is selected if a lack of Quality of Service, QoS, differentiation for buffered packets is acceptable.

In an embodiment, b) is selected if an increase in network signalling is acceptable.

According to a second aspect of the present invention, there is provided a network configured to perform the method of the first aspect.

Embodiments of the present invention provide a means for minimizing data loss in the case of donor-DU migration, which may or may not include a CU change. The applicable scenario is that of node migration, whereby the parent node of a node changes and the donor-DU changes, where the CU may or may not change.

Although a few preferred embodiments of the present invention have been shown and described, it will be appreciated by those skilled in the art that various changes and modifications might be made without departing from the scope of the invention, as defined in the appended claims.

Embodiments of the present invention provide differing means of addressing the problem of potential data loss, depending on the precise configuration of the network and the nature of the rerouting which is performed. Further, enhancements which can be based upon performance measurements may be provided, as required.

FIG. 3 shows a protocol stack associated with an IAB network, such as that illustrated in FIG. 1 or 2. The BAP layer is clearly shown above the RLC layer.

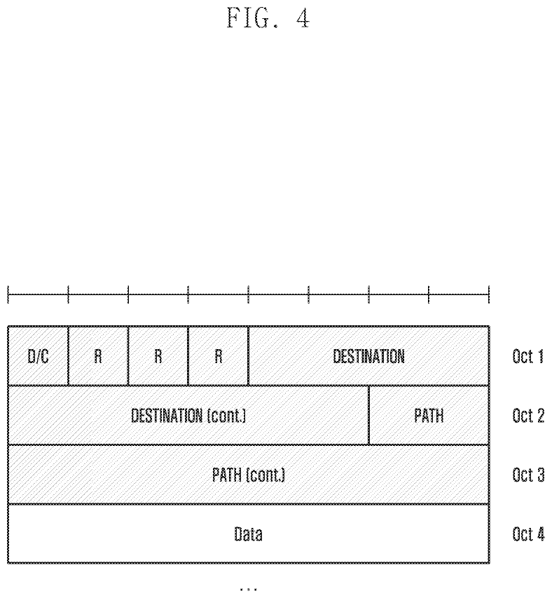

FIG. 4 shows a BAP Protocol Data Unit (PDU). The first octet comprises a first bit (D/C) indicating if the PDU is data or control, second to fourth reserved bits and then 10bits of destination address and 10bits of path, followed by the data to be transported, such as an IP packet.

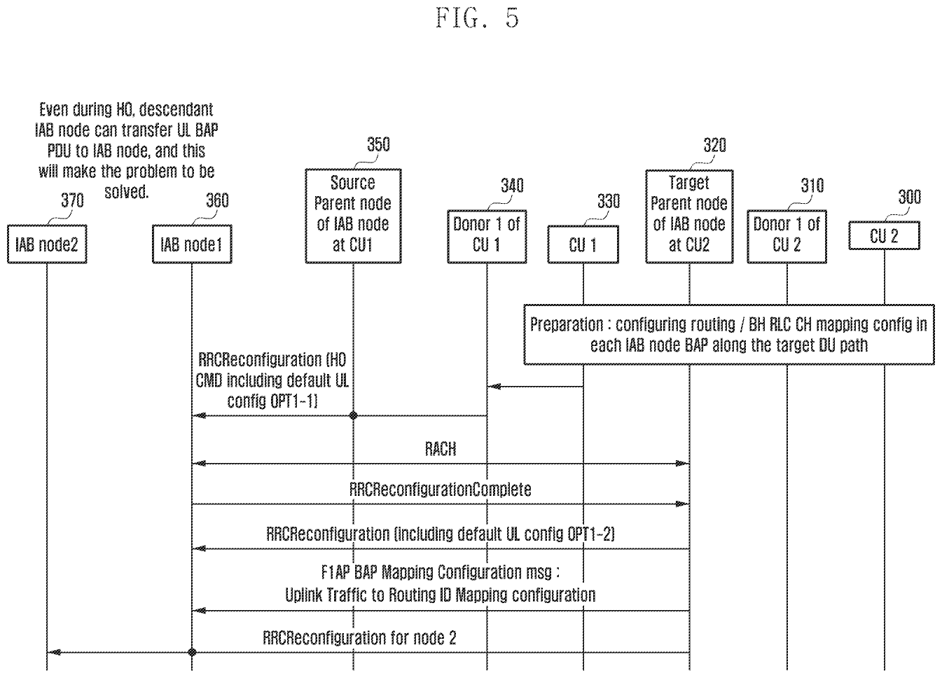

FIGS. 5 to 7 illustrate various messages associated with different embodiments of the present invention. The entities in each case are the same, but the nature of the messaging differs.

The entities involved are: A second CU (300); Donor1 of second CU (310); target parent node of IAB node at second CU (320); a first CU (330); Donor1 of first CU (340); source parent node of IAB node at first CU (350); IAB node 1 (360); and IAB node 2 (370).

In contrast to FIG. 2, which illustrates the case where the donor DU changes, but the CU remains the same (i.e. intra-CU, inter-DU migration), FIGS. 5 to 7, however, illustrate situations where the CU changes.

As such, these figures show the old CU (330) and the target CU (300), and the old donor-DU (340) and the target donor-DU (310).

The Source parent node (350) and target parent node (320) are old and new parent nodes of the node being migrated. It is not possible to provide a direct mapping of the entities in FIGS. 5 to 7 to the entities shown in FIG. 2, since in FIG. 2 the parent of the migrating node is actually the donor-DU itself, but the skilled person will appreciate that a parent node is either another IAB node, or a donor-DU.

In a first embodiment, a default Uplink (UL) F1-U configuration, comprising default BAP routing ID and/or Backhaul Radio Link Control Channel (BH RLC CH), is used to re-route all the packets impacted by the migration of the backhaul from old DU 122 to the new DU 123. This default configuration can be used when no routing entry can match the BAP routing ID.

The sequence of messages between entities is illustrated in FIG. 5.

This figure shows two sub-options for configuring the default UL F1-U configuration:

OPT1-1: Use Handover (HO) CMD (RRCReconfiguration); or

OPT1-2: Use additional RRCReconfig message after RRCReconfigurationComplete message

If there are descendant nodes under IAB node, the RRCReconfiguration (HO CMD) can be used as well to configure default UL F1-U configuration for these nodes.

In a further refinement of this embodiment, the HO CMD is sent to descendant nodes before migrating the parent IAB node. In normal operation, the descendant node checks the entries in the routing table (which may now be outdated, since the BAP address of the migrated parent node has changed) and then routes the data. In essence, there will be available links but the current behaviour will use the already configured routing tables and this can lead to loss of data, especially if the descendant node receives the default BAP Routing ID and default BH RLC channel configuration before or in parallel with the handover of the migrating IAB-node.

Embodiments of the invention therefore provide a procedure whereby the default BAP routing ID and BH RLC channel are configured to descendant nodes before the migrating IAB node completes its HO procedure.

For intra-CU/inter-DU migration, i.e. source and target DU are different but under the control of the same CU, the BAP reconfiguration to descendant nodes may not be needed. However, for inter-CU migration, as illustrated in FIGS. 5 to 7 particularly, i.e. where migration is to a DU controlled by a different CU, in a refinement of the present embodiment, the BAP address may be changed for descendant nodes as well, since those BAP addresses are assigned by the target CU, which is now different to the previously controlling CU.

In a second embodiment, the BAP header change (a list of BAP routing ID information updates, each item including old BAP routing ID and new BAP routing ID) is applied to each packet impacted by the migration individually and used for packet re-routing to the new destination.

The BAP header change can be configured via RRCReconfiguration (HO CMD). If the CU changes then, additionally, the BAP routing ID notification may be sent over Xn i.e. the source CU informs the target CU of the BAP routing IDs of the buffered packets, so that the target CU can generate the configuration for BAP header change.

According to the second embodiment, depending on the particular network design there may be a time gap between reception of HO CMD (containing BAP header change configuration), and reception of F1AP, which provides the signalling service between a CU and a DU, including new routing configuration.

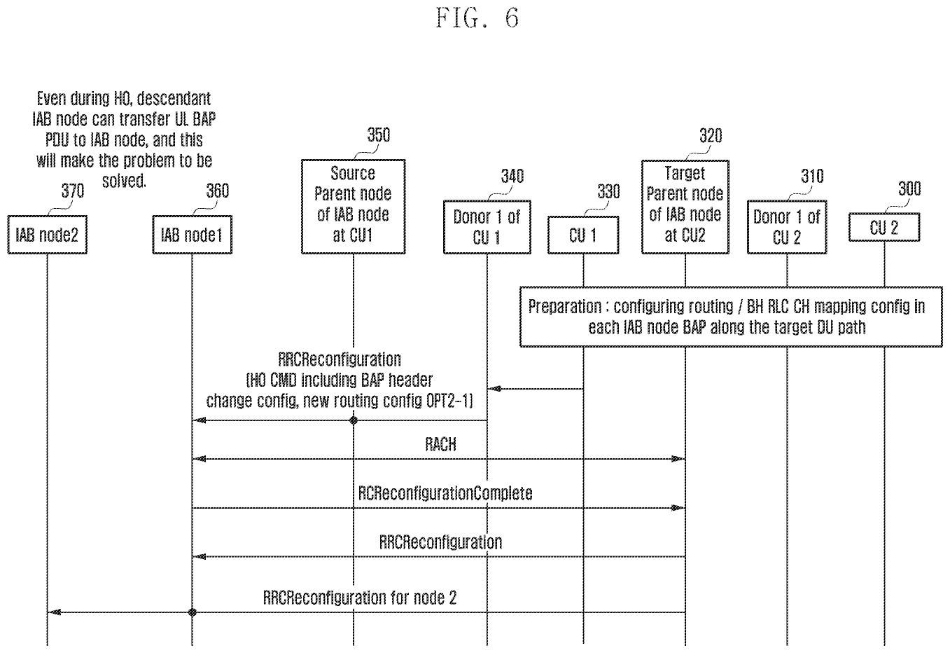

There are two possible implementations which can address this particular scenario. In a first option (OPT2-1), header change configuration and new routing configuration are both contained in HO CMD, as shown in FIG. 6. In this case, impacted packets are simply buffered until RRC configuration is completed.

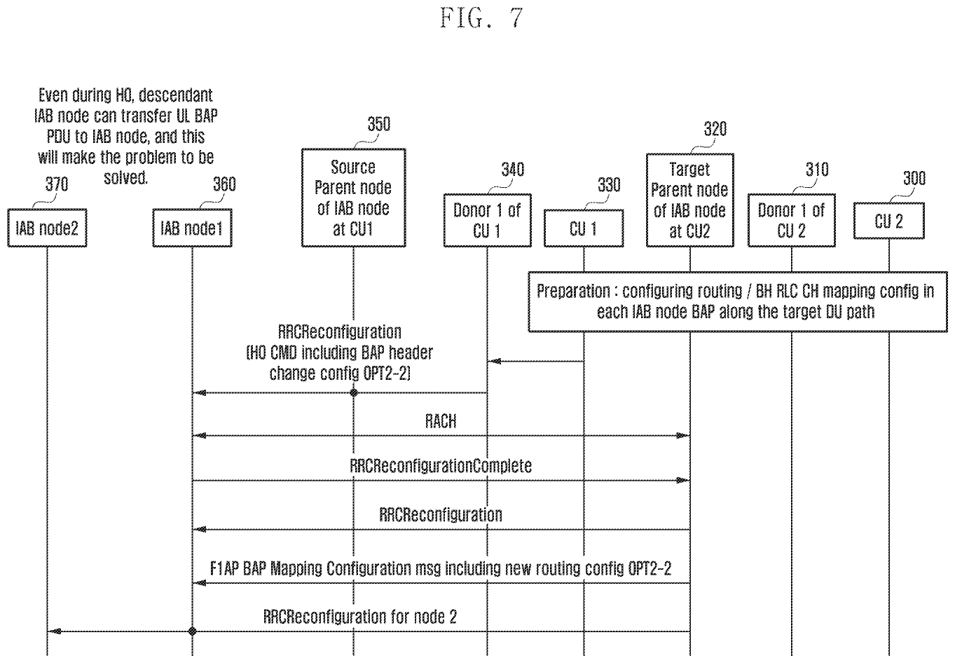

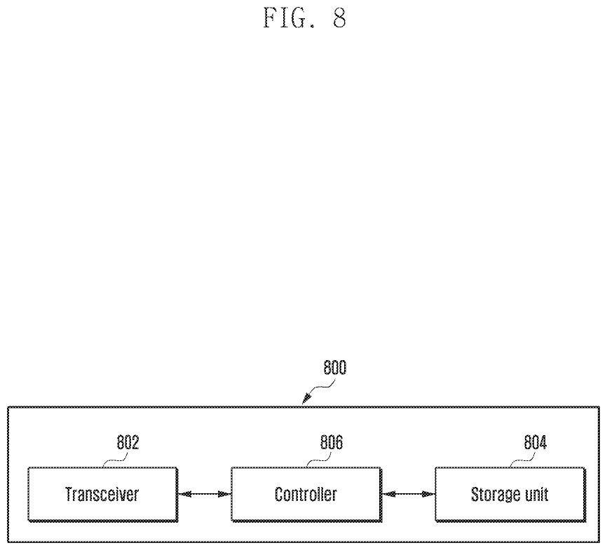

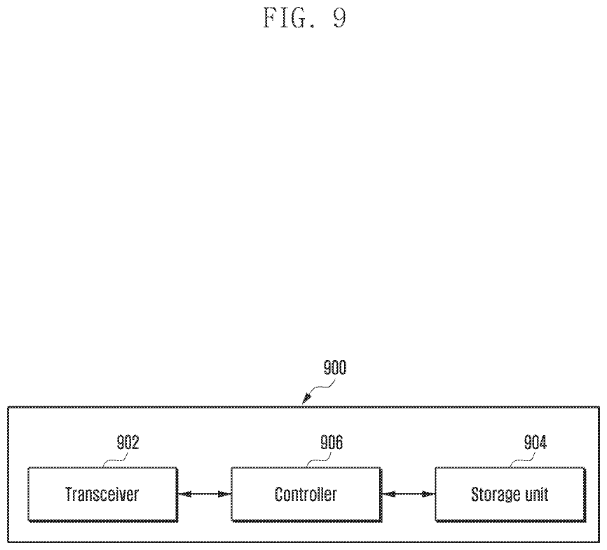

In a second option (OPT2-2), header change config is in HO CMD, while new routing config is received in a relevant F1Ap message after RRCReconfigComplete, as shown in FIG. 7.

In this case, the BAP header is changed, but does not match the old routing entry, and affected packets require special handling, such as being flagged and/or singled out. In other words, the packets with changed BAP header may not be routable since the old routing table does not contain an entry towards the new donor DU 123. Some packets, i.e. those with a changed BAP header, will not be routable, while others will be routable, such as those packets going towards the old DU 122 or a different DU al-together in the case of Dual Connectivity.

It is therefore desirable to somehow mark those packets which should not be immediately routed but should, instead, be buffered until a new routing configuration is received.

One option is that the BAP header change is only applicable for the migrated IAB node, and the migrated IAB node should be configured with, old/new BAP routing ID, next-hop node, BH RLC CHs, which is similar to the routing and mapping configuration. Note that such configurations are originally configured via F1AP.

Besides normal F1AP configuration (including routing configurations, and BH RLC CH configs) given after RRComplete msg, additional information intended or applicable only for packets unmatched with a routing entry can be given. The contents are those listed above, and this might still be via F1AP or HO CMD.

The solution mentioned immediately above is similar to the second option described in relation to the second embodiment, i.e. HO CMD contains the header rewriting configuration, while the new routing table is configured after complete message and via F1AP. In this case, it will result in some interruption, since the time period between the reception of HO CMD and new routing configuration does not allow any packet transmission at the migrated IAB node.

A solution to this issue is not to use F1-AP for routing configuration.

Alternatively, as per another refinement, it is possible to proceed as per the second option of the second embodiment, but provide the node with additional information for the packets which are no longer routable (such as identifying those packets in advance i.e. before the new routing configuration is received, by their destination BAP address, by their routing ID, by a position in a table) via RRC or via additional (new) F1-AP messages.

In Table 1 below, a comparison between the first and second options of the second embodiment is presented, which can be used to determine which option to deploy, and/or to switch between the use of different options depending on changes in the network.

TABLE 1

| | Signaling enhancement | Possible disadvantage |
|---|---|---|
| Option | Default UL F1-U configuration | No QoS differentiation for |
| 1 | (e.g., BAP routing ID, BH RLC | buffered packets |
| | CH) via RRCReconfiguration | (Note that this may not be a |
| | | big problem since the number |
| | | of buffered packets during the |
| | | migration procedure may not |
| | | be large) |
| Option | Configurations for BAP header | Large signaling impact |
| 2 | change in RRCReconfiguration | |
| | message | |
| | Configuration release for BAP | |
| | header change | |
| | BAP routing ID notification over | |
| | Xn for inter-CU case | |

In essence, which option to select can be based on one or more of the characteristics presented above, with the actual implementation being selected by the network operator as required.

FIG. 8 is a block diagram of a base station according to one embodiments of the present disclosure.

With reference to FIG. 8, a base station 800 of embodiments includes a transceiver 802, a storage unit 804 and a processor 806.

The transceiver 802 is capable of transmitting/receiving signals to/from UE and/or other network entity.

The storage unit 804 is capable of storing at least one of the following: information related to the base station 800 and information transmitted/received via the transceiver 802. In the embodiment, the storage unit 804 is capable of storing context information regarding UE and buffering transfer data.

The processor 806 is capable of controlling operations of the base station 800. The processor 806 is capable of controlling the base station to perform operations related to base station as described in the embodiments.

The base station may be the IAB node or IAB donor.

FIG. 9 is a block diagram of a terminal according to one embodiments of the present disclosure.

With reference to FIG. 9, a terminal 900 of embodiments includes a transceiver 902, a storage unit 904 and a processor 906.

The transceiver 902 is capable of transmitting/receiving signals to/from base station and/or other network entity.

The storage unit 904 is capable of storing at least one of the following: information related to the terminal 900 and information transmitted/received via the transceiver 902.

The processor 906 is capable of controlling operations of the terminal 900. The processor 906 is capable of controlling the terminal to perform operations related to terminal as described in the embodiments.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method performed by an integrated access and backhaul (IAB) node in a communication system, comprising:
identifying that the IAB node is migrated from a first IAB donor node to a second IAB donor node; and
changing a header of a data packet based on a routing identifier (ID).

2. The method of claim 1, wherein the changing the header of the data packet is performed by a backhaul adaptation (BAP) entity in the IAB node.

3. The method of claim 1, wherein the identifying comprises:
identifying that the IAB node is migrated from a first IAB donor CU of the first IAB donor node to a second IAB donor CU of the second IAB donor node.

4. The method of claim 1, wherein the changing the header of the data packet comprises:
rewriting an old backhaul adaptation (BAP) routing ID to a new BAP rouging ID in the header.

5. The method of claim 1, further comprising:
receiving, from the first IAB donor node, configuration information for changing the header.

6. The method of claim 5, wherein the configuration information is included in an F1AP message.

7. The method of claim 1, wherein the routing ID comprises information on an address and information on a path.

8. The method of claim 1, wherein the data packet is to be routed to the second IAB donor node.

9. An integrated access and backhaul (IAB) node A in a communication system, the IAB node comprising:
a transceiver; and
a controller coupled with the transceiver and configured to:
identify that the IAB node is migrated from a first IAB donor node to a second IAB donor node, and
change a header of a data packet based on a routing identifier (ID).

10. The IAB node of claim 9, wherein the changing the header of the data packet is performed by a backhaul adaptation (BAP) entity in the IAB node.

11. The LAB node of claim 9, wherein the controller is configured to:
identify that the IAB node is migrated from a first IAB donor CU of the first IAB donor node to a second IAB donor CU of the second IAB donor node.

12. The LAB node of claim 9, wherein the controller is configured to:
rewrite an old backhaul adaptation (BAP) routing ID to a new BAP rouging ID in the header.

13. The LAB node of claim 9, wherein the controller is configured to:
receive, from the first IAB node, configuration information for changing the header.

14. The LAB node of claim 13, wherein the configuration information is included in an F1AP message.

15. The LAB node of claim 9, wherein the routing ID comprises information on an address and information on a path.

16. The IAB node of claim 9, wherein the data packet is to be routed to the second IAB donor node.
